(19) United States
(12) Patent Application Publication
(10) Pub. No.: US 2006/0056277 A1
(43) Pub. Date: Mar. 16, 2006

(54) Optical recording medium base on a tellurium and zinc alloy

(75) Inventors: Ludovic Poupinet, Sassenage (FR); Berangere Hyot, Grenoble (FR); Marie-Francoise Armand, Vaulnaveys-Haut (FR)

Correspondence Address: OLIFF & BERRIDGE, PLC, P.O. BOX 19928, ALEXANDRIA, VA, 22320, US

(73) Assignees: Commissariat A L'Energie Atomique, Paris (FR); MPO International, Averton (FR)

(21) Appl. No.: 10/535,338

(22) PCT Filed: Dec. 2, 2003
(86) PCT No.: PCT/FR03/03547

§ 371 Date: Oct. 19, 2005

(30) Foreign Application Priority Data
Dec. 3, 2002 (FR) 02/15194

(51) Int. Cl. G11B 7/00

(52) U.S. Cl. 369/125

(57) ABSTRACT

The optical recording medium comprises an active layer made of inorganic material, presenting a front face for receiving an optical radiation during writing operations, and a rear face. The inorganic material is a tellurium and zinc alloy comprising an atomic percentage of between 60% and 70% of zinc and between 30% and 40% of tellurium. The alloy comprises preferably 65% of zinc and 35% of tellurium. The medium may comprise a semi-reflecting layer arranged on the front face of the active layer and/or an additional metal layer arranged on the rear face and/or a protective layer of polymer material on the rear face. Thus, writing powers, a mark resolution and a storage density corresponding to DVD format specifications may be achieved.

### BACKGROUND OF THE INVENTION

The invention relates to an optical recording medium comprising an active layer made of inorganic material, presenting a front face for receiving an optical radiation during writing operations, and a rear face.

### STATE OF THE ART

Optical recording can be performed in colorant materials (for example in CD-R: compact disk recordable and DVD-R: digital versatile disk recordable type applications), but also in inorganic materials. The latter present an advantage in terms of production cost and performances at high linear speeds. There are different methods of writing in a layer of inorganic material. The irreversible technique the most widely studied in the 80's consists in forming marks by laser ablation. The presence of the mark results in a local reduction of the reflection of a laser beam on the surface of the disk. This reduction of the reflection is read with a lower laser power. Even if most of the studies on ablation mechanisms concerned tellurium alone, other materials were envisaged, for example alloys containing arsenic, antinomy, selenium and sulphur, proposed in the article “Chalcogenide thin films for laser-beam recordings by thermal creation of holes” by M. Terao et Al. (J. Appl. Phys. 50 (11), November 1979). However in most of these studies, high powers were used, in particular by M. Terao et Al. The tests carried out at the time therefore did not correspond to the current writing specifications. Indeed, the powers used were in fact comprised between 40 mW and 300 mW and the dimensions of the marks were about 10 μm, whereas the writing powers used to write a DVD-R have to be about 10 mW and the dimension of a mark has to be about 400 nm in diameter. Moreover, it is often necessary to deposit a protective layer, for example of polymer, on the recording medium. However, the presence of a protective layer generally causes a degradation of the quality of the signals and an increase of the writing power. Many materials were studied, but few enable good quality writing, in particular tellurium and its alloys with germanium, selenium and antimony. Unfortunately, these alloys do not enable the storage densities required for DVD format to be achieved. This is why colorants imposed themselves for this standard. However, irreversible optical recording technologies in colorant materials sometimes present high costs, in particular the prices of the colorants and the manpower costs for the colorant handling stages.

### OBJECT OF THE INVENTION

The object of the invention is to remedy these shortcomings and, more particularly, to propose an inorganic medium enabling a mark resolution and storage density corresponding to DVD format specifications to be achieved.

According to the invention, this object is achieved by the fact that the inorganic material is a tellurium and zinc alloy comprising an atomic percentage of between 60% and 70% of zinc and between 30% and 40% of tellurium.

According to a preferred embodiment, the alloy comprises 65% of zinc and 35% of tellurium.

According to a development of the invention, the medium comprises a semi-reflecting layer arranged on the front face of the active layer and having a thickness comprised between 6 nanometers and 9 nanometers.

According to another feature of the invention, the medium comprises an additional metal layer with a thickness comprised between 9 nanometers and 12 nanometers, arranged on the rear face of the active layer.

According to another development of the invention, the medium comprises a protective layer of polymer material on the rear face.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents a particular embodiment of an optical recording medium according to the invention.

FIG. 2 represents a particular embodiment of a medium according to the invention comprising a semi-reflecting layer.

FIG. 3 represents a particular embodiment of a medium according to the invention comprising an additional metal layer.

FIG. 4 represents a particular embodiment of a medium according to the invention comprising a protective layer.

### DESCRIPTION OF PARTICULAR EMBODIMENTS

In FIG. 1, an optical recording medium comprises a substrate 1 and an active layer 2 made of inorganic material, presenting a front face 3 for receiving an optical radiation 4 during writing operations, and a rear face 5. The substrate 1 is arranged on the front face 3 of the active layer 2. Typically, the active layer 2 is deposited on a plastic substrate, for example made of polycarbonate. The medium can be read on both sides, i.e. the active layer 2 can receive an optical radiation, during reading operations, on the front face 3 or on the rear face 5 thereof. The writing mechanism used is preferably a mechanical deformation mechanism, for example holes or bubbles. The optical recording medium can in particular be of irreversible type.

The inorganic material of the active layer 2 is a tellurium and zinc alloy comprising an atomic percentage of between 60% and 70% of zinc and between 30% and 40% of tellurium. This alloy presents advantageous properties for formation of marks by laser, for example deformation of the layer, formation of a bubble and formation of a hole. In a preferred embodiment, the alloy comprises 65% of zinc and 35% of tellurium. The active layer preferably has a thickness comprised between 15 nanometers and 50 nanometers. The thickness has to be adjusted to enable a reasonable writing power with a sufficient reflection to be preserved. The marks, for example holes or cavities, do in fact have to be sufficiently large to create the required reflection contrast but not too large in order to limit the reading noise. But the size of the marks in fact increases with the thickness of the layer. In a preferred embodiment, the thickness of the active layer 2 is comprised between 20 nanometers and 25 nanometers enabling a reflection coefficient comprised between 15% and 20% to be obtained. In another preferred embodiment, the thickness of the active layer 2 is 40 nanometers enabling a reflection coefficient comprised between 25% and 35% to be obtained.

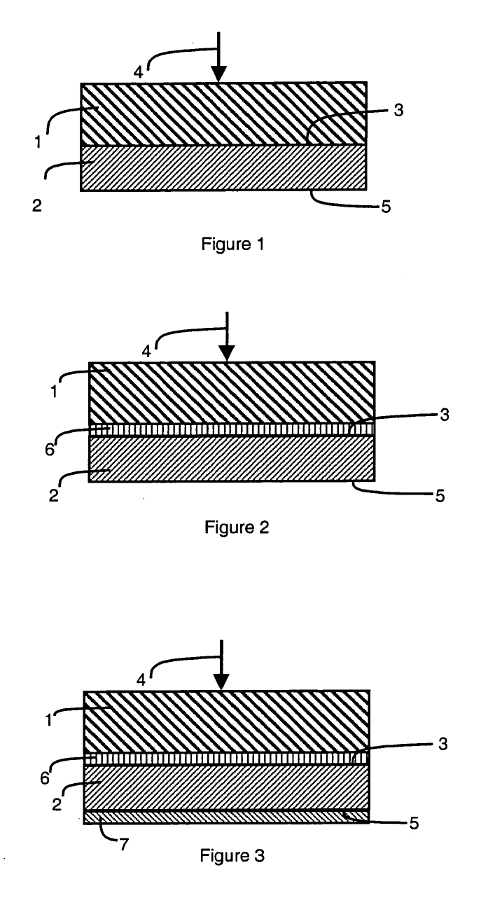

As represented in FIG. 2, the optical recording medium can comprise a semi-reflecting layer 6 arranged on the front face 3 of the active layer 2. It is preferable for this layer to absorb little light. As the optical radiation having to reach the active layer 2 passes through the semi-reflecting layer 6, the thickness of the latter has to be adjusted as best as possible to increase the reflection without increasing the write threshold excessively. The semi-reflecting layer 6 has a thickness comprised between 4 nanometers and 10 nanometers. In this way, the reflection coefficient of the whole of the active layer 2 and of the semi-reflecting layer 6 can be adapted to the detection device.

In a preferred embodiment, the semi-reflecting layer 6 is made from a metal taken from the group comprising aluminium, gold, silver, copper, zinc, titanium, nickel and alloys thereof. These metals form part of the standard thin film technology materials being able to present sufficiently high reflection and transmission coefficients in the range of wavelengths typically used for reading operations. Aluminium seems to be a particularly suitable metal, on account of the fact that it presents a strong reflection throughout the optical spectrum.

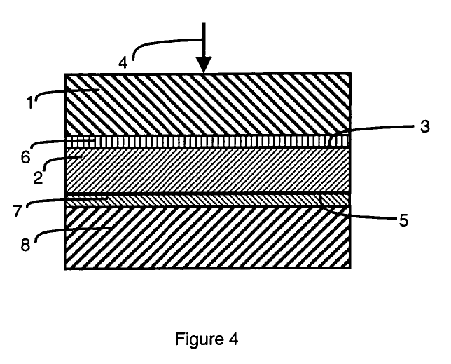

In FIG. 3, the recording medium comprises an additional metal layer 7 arranged on the rear face 5 of the active layer 2. The additional metal layer 7 enables the heat dissipation in the active layer 2 when writing operations are performed to be increased. The active layer 2 is thus cooled more quickly, in particular on the rear face. This limits the deformation to which the molten material is subjected during creation of a mark and therefore limits the final size of the marks.

In a preferred embodiment, the additional metal layer 7 has a thickness comprised between 9 nanometers and 12 nanometers. The preferred thickness of the additional metal layer 7 is 10 nanometers. The essential property of the additional metal layer 7 is thermal conductivity. The material of the additional metal layer 7 is preferably taken from the group comprising aluminium, gold, silver, copper and alloys thereof. These metals are in fact good heat conductors among the standard thin film technology materials.

The medium comprising the active layer 2 and the additional metal layer 7 enables writing operations to be performed with a power compatible with the powers required by writing standards. Thus, the dimension of the marks does not exceed the dimension required by the writing specifications. By applying higher writing powers, the size of the marks increases and exceeds the tolerated dimension.

A consequence of the presence of the additional metal layer 7 of small thickness can be the reduction of the reflection of the whole of the medium, unlike a thicker metal layer (about 100 nanometers), which is sometimes arranged, to increase the reflection, on the rear face of the organic active layer in organic colorant-based technologies. The interface between a metal layer and an organic layer in fact presents different reflection properties of the interface between the active layer 2 made of inorganic material and the additional metal layer 7, because the organic layer is transparent, whereas the inorganic active layer 2 made of alloy is opaque.

In FIG. 4, the optical recording medium comprises, in addition, a protective layer 8, preferably made of deformable material, for example polymer material, on the rear face 5, enabling the disk to be protected from physico-chemical modifications of the materials, for example oxidation, and from mechanical modifications, for example scratches. The protective layer 8 is preferably polydimethylsiloxane-based and has a thickness preferably comprised between 10 micrometers and 100 micrometers. Assembly of the protective layer 8 and of a medium comprising an active layer 2 of zinc and tellurium alloy with the percentages according to the invention is easy to implement and the presence of a polymer layer does not cause any degradation of the writing signal. The layer 8 can be replaced by a gluing layer with a thickness of 20 to 100 micrometers whereon there is arranged a plastic layer, for example a layer of polycarbonate with a thickness of 0.6 mm.

Optical recording media according to the invention have been tested under conditions corresponding to the DVD-R standard. Thus, marks with a minimum length of 400 nm and a maximum length of 1866 nm were etched by optical radiation pulses of corresponding durations, notably with a minimum duration of 3T and a maximum duration of 14T, where T is the optical signal generator clock pulse time. As the length of the marks is smaller than the wavelength of the optical radiation used, it is not possible to measure the length of the marks by observation under a microscope. However the length of the marks can be deduced, in known manner, from the quantity of radiation reflected by a sequence of marks scanned by an optical radiation. Thus, a histogram of the lengths of the measured marks can be established. The standard deviation of each histogram (jitter) of the minimum marks (3T) and maximum marks (14T) is less than 8%.

1-11. (canceled)

12. Optical recording medium comprising an active layer made of inorganic material, presenting a front face for receiving an optical radiation during writing operations, and a rear face, medium wherein the inorganic material is a tellurium and zinc alloy comprising an atomic percentage of between 60% and 70% of zinc and between 30% and 40% of tellurium.

13. Recording medium according to claim 12, wherein the alloy comprises 65% of zinc and 35% of tellurium.

14. Recording medium according to claim 12, wherein the active layer has a thickness comprised between 15 nanometers and 50 nanometers.

15. Recording medium according to any claim 12, comprising a semi-reflecting layer arranged on the front face of the active layer and having a thickness comprised between 4 nanometers and 10 nanometers.

16. Recording medium according to claim 15, wherein the semi-reflecting layer is made of metal taken from the group comprising aluminium, gold, silver, copper, zinc, titanium, nickel and alloys thereof.

17. Recording medium according to claim 12, comprising an additional metal layer arranged on the rear face of the active layer.

18. Recording medium according to claim 17, wherein the additional metal layer has a thickness comprised between 9 nanometers and 12 nanometers.

19. Recording medium according to claim 17, wherein the material of the additional metal layer is taken from the group comprising aluminium, gold, silver and copper.

20. Recording medium according to claim 12, comprising a protective layer of polymer material on the rear face.

21. Recording medium according to claim 20, wherein the protective layer is polydimethylsiloxane-based and has a thickness comprised between 10 micrometers and 100 micrometers.

22. Recording medium according to claim 20, wherein the protective layer is deformable.
